(19) United States
(12) Patent Application Publication
(10) Pub. No.: US 2009/0266792 A1
(43) Pub. Date: Oct. 29, 2009

(54) FABRICATION METHODS FOR PATTERNED STRUCTURES

(75) Inventor: Ying-Chi CHEN, Hsinchu Xian (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, Hsinchu (TW)

(21) Appl. No.: 12/338,864

(22) Filed: Dec. 18, 2008

Related U.S. Application Data
(60) Provisional application No. 61/047,511, filed on Apr. 24, 2008.

(30) Foreign Application Priority Data
Jul. 16, 2008 (TW) TW097126921

(51) Int. Cl. B44C 1/22

(52) U.S. Cl. 216/83

(57) ABSTRACT

Fabrication methods for patterned structures are presented. A layer of material is provided and a patterned region and a non-patterned region are formed using a multiple thermal writing head, wherein the patterned region and the non-patterned region have different physical properties. Alternatively, the layer of material is formed on a substrate. After the layer of material is transferred into the patterned and non-patterned regions, the non-patterned region is removed.

### CROSS REFERENCE TO RELATED APPLICATIONS

This application claims the benefit of U.S. Provisional Application No. 61/047,511 filed on Apr. 24, 2008, the entirety of which is incorporated herein by reference.

This application is based upon and claims the benefit of priority from a prior Taiwanese Patent Application No. 097126921, filed on Jul. 16, 2008, the entire contents of which are incorporated herein by reference.

### BACKGROUND OF THE INVENTION

1. Field of the Invention

The invention relates to a fabrication method for patterned structures, and in particular to a fabrication method for patterned structures using an apparatus with a multiple thermal writing head.

2. Description of the Related Art

Display panel have been developing towards regimes with large scale and flexibility. In order to achieve fast and precise production effects, conventional fabrication method for patterned structures include lithography, laser processing, inkjet printing, and thermal print-heat patterning.

Conventional lithography is beneficial due to well-developed. However, fabrication method using lithography is too complicated and expensive. Further, CO₂ laser processing is advantageous due to practical to use. A pattern is created by several laser-scanning lines such that fine traces are existed between the laser-scanning lines. Production throughput is very slow. The quality is not easy to control due to unstable laser source. On the other hand, inkjet printing is beneficial due to low production cost. Inkjet droplets, however, are not easy to apply on some materials. The quality of patterns is unstable due to volatilization of inkjet droplet and crooked ink trajectory.

U.S. Pat. No. 6,498,679, the entirety of which is hereby incorporated by reference, discloses a fabrication method for patterning phase retardation using CO₂ laser heating. Patterns with different phase retardation characteristics are formed by laser scanning line by line. Several laser-scanning lines are composed on a patterned region.

FIG. 1 is a schematic view illustrating layer-by-layer structure of a conventional micro retarder. Referring to FIG. 1, a phase retarder 14 includes a hatched area 14b and a blank area 14a with different phase retardations in which the hatched area 14b is the area exposed to the infra-red CO₂ laser, while the blank area 14a is not processed by the infra-red laser. Typically, the hatched area with zero phase retardation and the blank area with the phase retardation caused by the heating treatment alternating with each other. Both surfaces of the micro-retarder 14 are covered by the laminations of the layer of index matching glue and the protection layer 10 and 12, and 16 and 18, respectively. The hatched area 14b of the micro-retarder 14 is created by several laser-scanning lines such that fine traces and bubbles are existed between the laser-scanning lines. Production throughput is very slow. The quality of the micro-retarder 14 is not easy to control due to unstable laser heating source.

### BRIEF SUMMARY OF THE INVENTION

An embodiment of the invention provides a fabrication method for patterned structures, comprising: providing a layer of material; and forming a patterned region and a non-patterned region using a multiple thermal writing head, wherein the patterned region and the non-patterned region have different physical properties.

Another embodiment of the invention provides a fabrication method for patterned structures, comprising: providing a layer of material; and transferring a portion of the layer of material to a substrate using a multiple thermal writing head, thereby creating a patterned region onto the substrate, wherein the patterned region has a different composition from the substrate.

### BRIEF DESCRIPTION OF THE DRAWINGS

The invention can be more fully understood by reading the subsequent detailed description and examples with references made to the accompanying drawings, wherein:

FIG. 1 is a schematic view illustrating layer-by-layer structure of a conventional micro retarder;

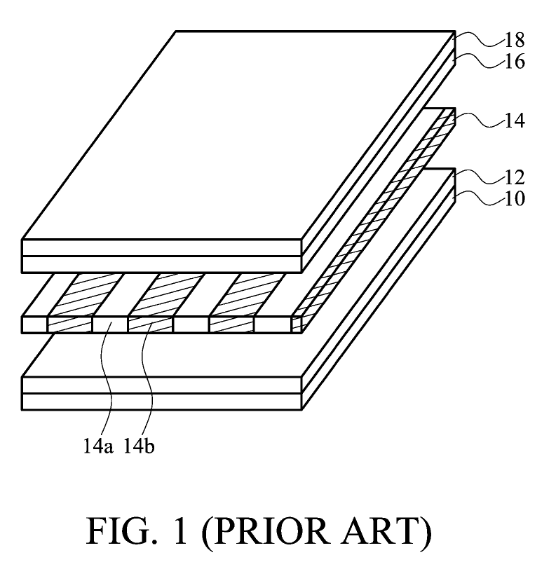

FIG. 2 is a schematic view of an embodiment of a thermal writing apparatus system of the invention;

FIG. 3A is a flow chart schematically illustrating an embodiment of a fabrication method for a phase retardation plate of the invention;

FIG. 3B is a flow chart schematically illustrating another embodiment of a fabrication method for a tin indium oxide electrode substrate of the invention;

FIG. 3C is a flow chart schematically illustrating another embodiment of a fabrication method for a color filter plate of the invention;

FIG. 4 is a schematic view of an embodiment of roll-to-roll process of the invention;

FIGS. 5A and 5B are schematically views showing en embodiment of a fabrication method for a 3D phase retarder using thermal writing techniques;

FIGS. 6A-6C are cross sections illustrating each step of a fabrication method for an ITO electrode substrate of the invention;

FIGS. 7A-7C are cross sections illustrating each step of a fabrication method for a donor film substrate of the invention.

### DETAILED DESCRIPTION OF THE INVENTION

It is to be understood that the following disclosure provides many different embodiments, or examples, for implementing different features of various embodiments. Specific examples of components and arrangements are described below to simplify the present disclosure. These are merely examples and are not intended to be limiting. In addition, the present disclosure may repeat reference numerals and/or letters in the various examples. This repetition is for the purpose of simplicity and clarity and does not in itself indicate a relationship between the various embodiments and/or configurations discussed. Moreover, the formation method for a first feature over or on a second feature in the description that follows may include embodiments in which the first and second features are formed in direct contact or not in direct contact.

Embodiments of the invention provide fabrication methods for patterned structures which are applicable to large scale flexible substrates and large scale display technologies. The exemplary thermal writing technique of the invention uses a thermal writing apparatus system to fabricate patterned flexible substrate structures and display panels.

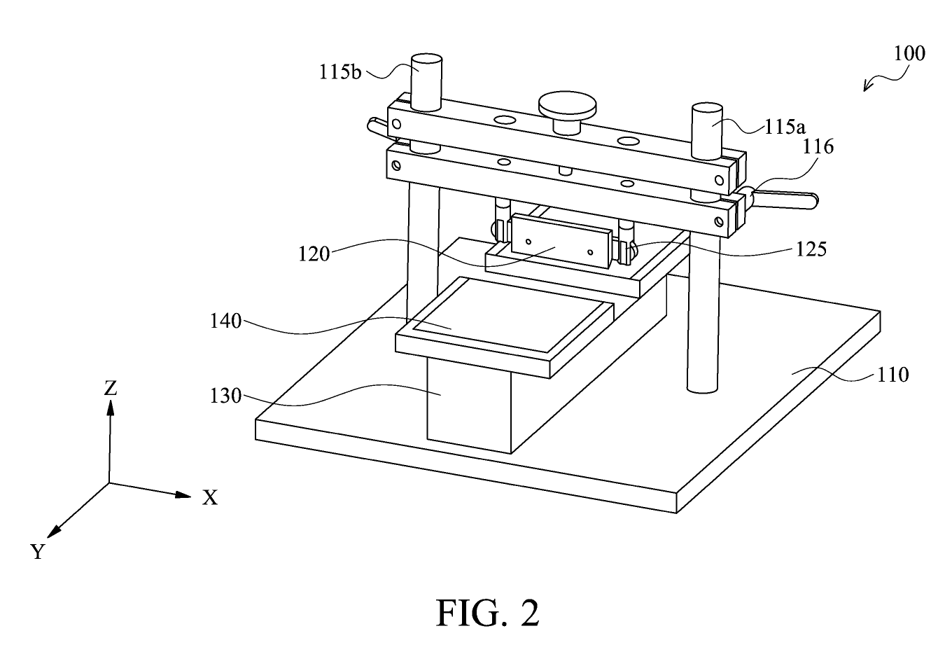

FIG. 2 is a schematic view of an embodiment of a thermal writing apparatus system of the invention. Referring to FIG. 2, a thermal writing apparatus system 100 includes a support stage 130 disposed on a base 110. The support stage 130 adopts a motor with precision bearings to precisely control movement of a vacuum chuck 140 for thermal writing. A desired patterned substrate or film is fixed to the thermal writing vacuum chuck 140. A beam is set up to a pair of vertical shafts 115a and 115b and fixed by a height adjusted means 116. A multiple thermal writing head set 120 is setup and fixed under the beam to micro-contact with the desired patterned substrate or film on the thermal writing vacuum chuck 140. The contact condition between the multiple thermal writing head set 120 and he desired patterned substrate or film can be adjusted and fine-tuned by an automatic horizontal adjusted means 125. The thermal writing apparatus system 100 further comprises a micro-processor and a controller (not shown) to control output of the multiple thermal writing head set 120.

According to one embodiment of the invention, the thermal writing apparatus system 100 includes means for adjusting a relative location (along z-axis) between the desired patterned working pieces (such as a material layer on the substrate) and the multiple thermal writing head set 120. The horizontal surface of the multiple thermal writing head set 120 can be automatically adjusted by the adjusted means 125. When patterning, the desired patterned working pieces can be held on the thermal writing vacuum chuck 140. The desired patterned working pieces on the thermal writing vacuum chuck 140 is addressed and controlled by the motor with precision bearings. When the desired patterned working pieces are conveyed by the motor with precision bearings, the working pieces are fixed on the thermal writing vacuum chuck 140, thereby achieving excellent patterned structures.

Other embodiments of the multiple thermal writing head set 120 of the invention uses special circular thermal writing head arranged in a linear heater line. Each circular thermal writing head can precisely concentrate energy on the desired patterned display panels or flexible substrates. A means for adjusting vertical height is disposed above the thermal writing head module to adjust and maintain the distance between the thermal writing head module and the desired patterned display panels or flexible substrates. Additionally, the conveying speed of the desired patterned working pieces can be controlled to change temperature which is applied on the working pieces. Thus, large scale printing is realized, as multiple writing points by multiple thermal writing head sets is achieved through designing the thermal writing heads. The heating energy provided by each thermal writing head of the thermal writing head module is stable and concentrated such that the thermal writing head can be very close to the desired patterned working pieces. Printed structures with clear fringes can thus be achieved.

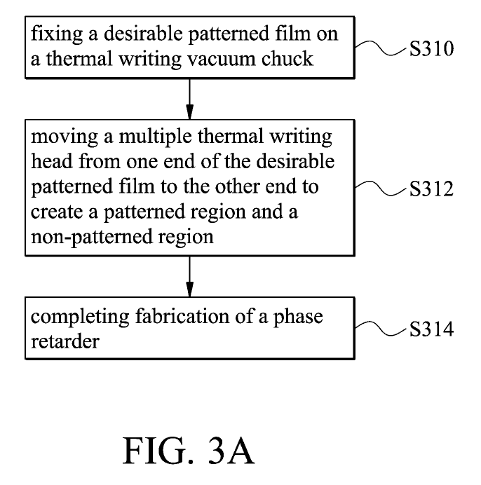

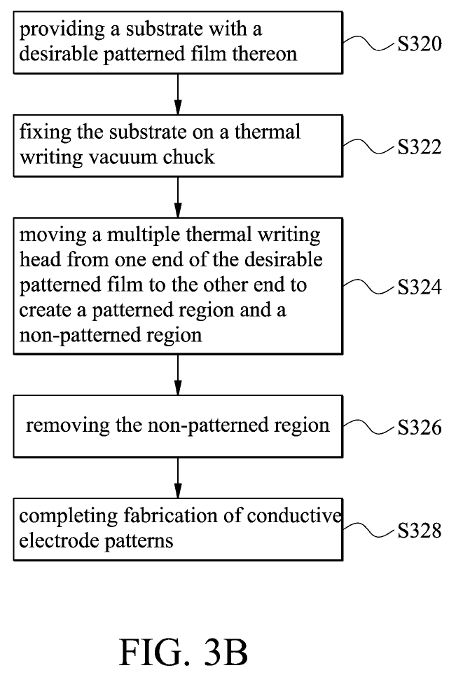

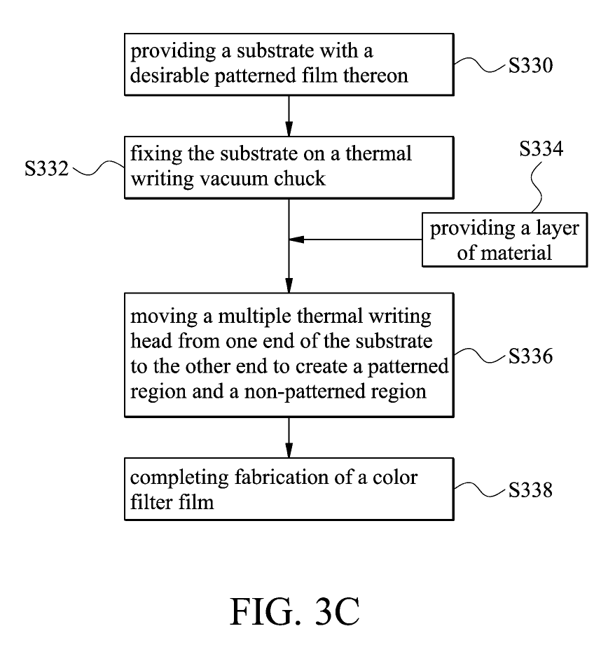

FIG. 3A is a flow chart schematically illustrating an embodiment of a fabrication method for a phase retardation plate of the invention. First, a desired patterned film (such as a polymer film) is fixed to a thermal writing vacuum chuck (step S310). Subsequently, the multiple thermal writing head moves from one end of the desired patterned film to the other end to create a patterned region and a non-patterned region (step S312), wherein the patterned region and the non-patterned region have different phase retardation properties to serve as a phase retarder of 3D display devices.

FIG. 3B is a flow chart schematically illustrating another embodiment of a fabrication method for a tin indium oxide electrode substrate of the invention. First, a substrate is provided. A layer of material to be patterned, such as a tin indium oxide (ITO) material, is disposed on the substrate (step S320). Subsequently, the substrate is fixed to a thermal writing vacuum chuck (step S322). The multiple thermal writing head moves from one end of the desired patterned layer of material to the other end to create a patterned region and a non-patterned region (step S324). The non-patterned region is then removed (step S326) leaving the patterned ITO electrode region, thereby completing fabrication of the tin indium oxide electrode substrate (step S328).

FIG. 3C is a flow chart schematically illustrating another embodiment of a fabrication method for a color filter plate of the invention. First, a substrate with a desired patterned film thereon is provided (step S 330). The substrate is fixed to a thermal writing vacuum chuck (step S332) or a layer of material is provided (step S334). For example, a donor film is disposed on the substrate. Subsequently, the multiple thermal writing head moves from one end of the desired patterned film to the other end transferring the donor film on the substrate to create a patterned region and a non-patterned region (step S336). Thus, fabrication of the color filter plate is completed (step S338).

Note that the abovementioned embodiments of the invention adopt thermal writing techniques to create fabrication methods that result in fast production, high efficiency, excellent quality, controlled and stable heating, and large-scale applicable. The fabrication methods for patterned structures using thermal writing techniques are applicable and compatible to automatic roll-to-roll processes.

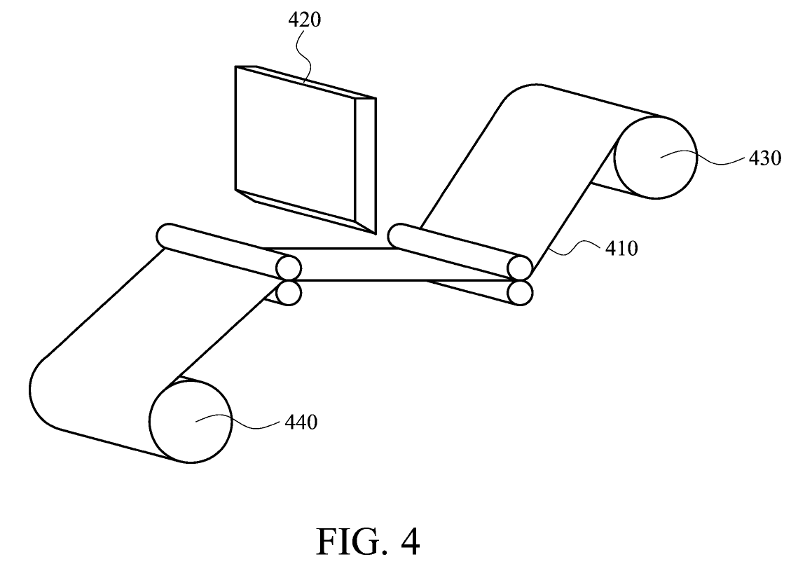

FIG. 4 is a schematic view of an embodiment of roll-to-roll process of the invention. Referring to FIG. 4, a flexible substrate 410 such as a polymer substrate is provided from a roller 430 to a roller 440. A thermal writing head module 420 is fixed and positioned above the flexible substrate 410. The conveying speed from the roller 430 to the roller 440 can be controlled to achieve continuous large-scale roll-to-roll fabrication of the patterned structures.

According to embodiments of the invention, the thermal writing techniques using the multiple thermal writing head are advantageous, in that heating energy is concentrated and stable and material characteristics are able to be controlled. Thus, the embodiments are applicable to fabrication of 3D phase retarders, ITO electrode substrates, and photoresists on flexible substrates. Specifically, problems associated with conventional laser scanning, such as low production throughput and pattern quality deficiencies can be mitigated. Moreover, fabrication using the thermal writing techniques of the invention can be used to replace the conventional lithography process, as photoresist can be directly transferred onto flexible substrates using thermal writing techniques of the invention.

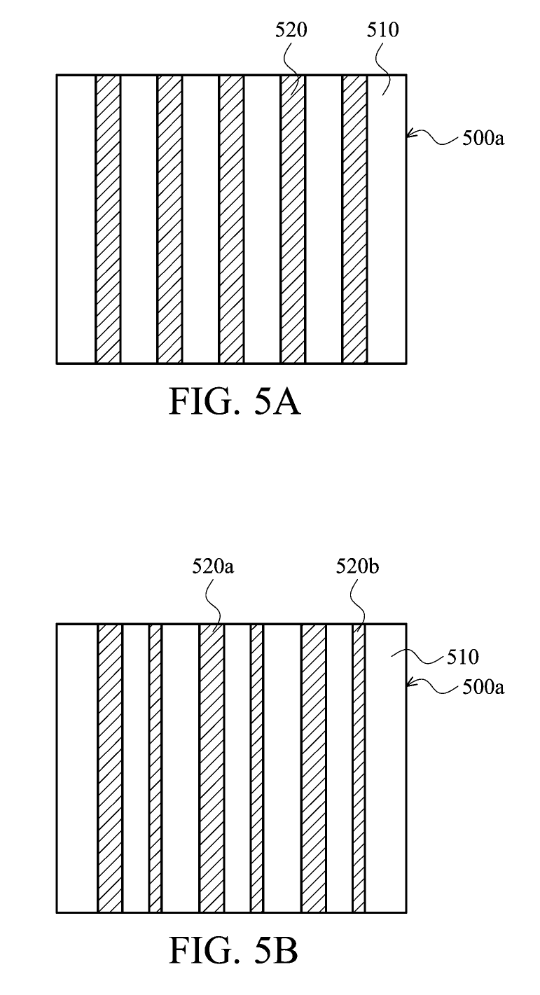

FIGS. 5A and 5B are schematically views showing en embodiment of a fabrication method for a 3D phase retarder using thermal writing techniques. Referring to FIG. 5A, a desired patterned film (such as a polymer film) 500a is patterned by using a multiple thermal writing head to create a patterned region 520 and a non-patterned region 510. The patterned structure can serve as a 3D phase retarder. The patterned region 520 can be periodic stripe patterns. The patterned region 520 can also include alternating strips 520a and 520b with different line widths, as shown in FIG. 5B. Alternatively, the patterned region 520 can be other geographic shapes, such as grid patterns.

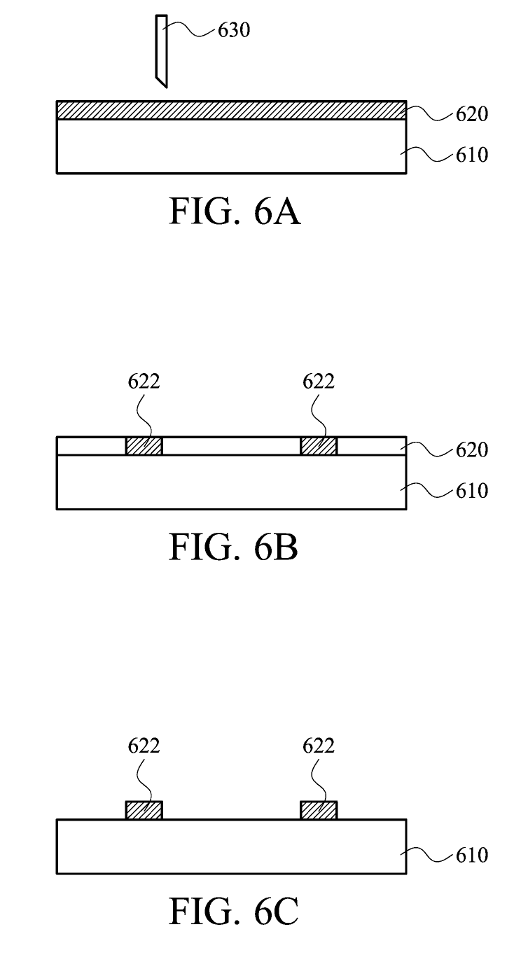

FIGS. 6A-6C are cross sections illustrating each step of a fabrication method for an ITO electrode substrate of the invention. Referring to FIG. 6A, a substrate 610 is provided. An ITO electrode layer 620 is formed on the substrate 610. The multiple thermal writing head 630 moves from one end (e.g., the left end) of the substrate 610 to the other end (e.g., the right end), thereby creating a patterned ITO electrode region. For example, the ITO layer is heated and transformed into a crystallized ITO electrode 622, as shown in FIG. 6B.

Referring to FIG. 6C, the non-patterned ITO electrode region 620 is then removed leaving the patterned ITO electrode region 622, thereby completing fabrication of the tin indium oxide (ITO) electrode substrate.

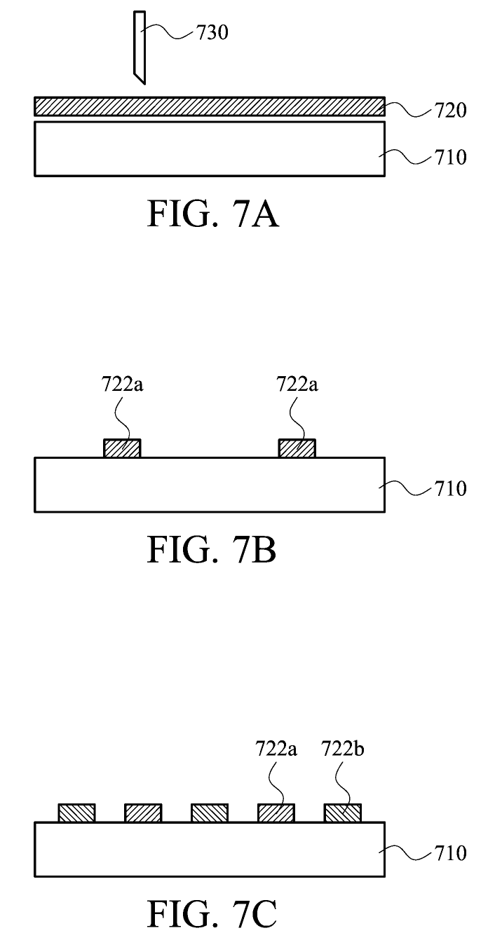

FIGS. 7A-7C are cross sections illustrating each step of a fabrication method for a donor film substrate of the invention. Referring to FIG. 7A, a substrate 710 is provided. A donor film 720 is disposed over the substrate 710. The donor film can be a dry photoresist film or a color filter film. The multiple thermal writing head 730 moves from one end (e.g., the left end) of the substrate 710 to the other end (e.g., the right end), thereby transferring a patterned region 722a onto the substrate 710, as shown in FIG. 7B.

Subsequently, another donor film (not shown) can optionally be disposed over the substrate 710. The thermal writing procedure is repeated. Another patterned region 722b is transferred onto the substrate 710, as shown in FIG. 7C.

Embodiments of the invention using the thermal writing techniques are stable and heating energy is concentrated, therefore being applicable to patterning ITO flexible structures replacing the conventional photolithography method. Furthermore, the thermal writing techniques can be compatible with roll-to-roll flexible fabrication methods. A color material can be transferred onto a flexible material with excellent effects.

While the invention has been described by way of example and in terms of the embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fabrication method for patterned structures, comprising:
providing a layer of material; and
forming a patterned region and a non-patterned region using a multiple thermal writing head, wherein the patterned region and the non-patterned region have different physical properties.

2. The fabrication method as claimed in claim 1, wherein the layer of material comprises a polymer material to serve as a phase retarded plate.

3. The fabrication method as claimed in claim 2, wherein the multiple thermal writing head moves from one end of the layer of material to the other end, thereby patterning the layer of material.

4. The fabrication method as claimed in claim 1, wherein the layer of material is a roll-to-roll substrate.

5. The fabrication method as claimed in claim 1, wherein the patterned region and the non-patterned region have different phase retardation characteristics.

6. The fabrication method as claimed in claim 1, wherein the layer of material is formed on a substrate.

7. The fabrication method as claimed in claim 6, wherein the layer of material comprises a tin indium oxide.

8. The functional device array as claimed in claim 6, further comprising removing the non-patterned region.

9. A fabrication method for patterned structures, comprising:
providing a layer of material; and
transferring a portion of the layer of material to a substrate using a multiple thermal writing head, thereby creating a patterned region onto the substrate,
wherein the patterned region has a different composition from the substrate.

10. The fabrication method as claimed in claim 9, wherein the layer of material comprises a color layer.

11. The fabrication method as claimed in claim 9, wherein the multiple thermal writing head moves from one end of the layer of material to the other end, thereby patterning the layer of material.

12. The fabrication method as claimed in claim 9, wherein the layer of material is a roll-to-roll substrate.
